(19) United States
(12) Patent Application Publication
(10) Pub. No.: US 2004/0169661 A1
(43) Pub. Date: Sep. 2, 2004

(54) Method and device for automatic generation of geomatic applications

(76) Inventor: Ahmed Lbath, Villeurbanne (FR)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/467,083

(22) PCT Filed: Dec. 4, 2002
(86) PCT No.: PCT/FR02/04173

(30) Foreign Application Priority Data
Dec. 6, 2001 (FR) 01 15773

(51) Int. Cl. G09G 5/00

(52) U.S. Cl. 345/619

(57) ABSTRACT

The invention relates to a process for realising geomatic applications.

The process according to the invention comprises the steps of:

defining a file which describes a geomatic application in a format which is liable to be exploited by a plurality of various Geographic Information Systems (GIS);

selecting a particular geographical information system among the plurality of various Geographic Information Systems;

translating the defined file into a language which is specific to the selected Geographic Information System.

### TECHNICAL BACKGROUND

The invention relates to the domain of geomatics and more precisely to a process and a device for automatic generation of geomatic applications.

### PRIOR ART

Geomatics is a discipline whose purpose is to provide computerised tools to the Geographic Information Systems (GIS) allowing to enhance geographic information, phenomena and trends observable over a given area.

A GIS is a set of tools and spatially localised data which permits to facilitate plotting of geographic maps for imagery and provide assistance in decision making. A GIS includes acquisition, processing, displaying and cartographic production tools.

The Geographic Information Systems (GIS) have been the object of a tremendous development in the last ten years, mainly in domains such as patrimony management, public lightening, green spaces and water distribution management, geomarketing, etc.

FIG. 1 is a general block-diagram of a GIS, wherein a geographic data base 2 is linked with a data acquisition module 4 which comprises, following the current art, aerial or satellite pictures acquisition tools and digitising tools to convert these pictures into files. Acquisition module 4 delivers digitised geographic maps to data base 2. Data base 2 is linked with a data management module 6 and with a spatial analysis module 8 respectively intended for establishing a correspondence between alphanumeric objects and geographic objects and for completing analysis and/or screening over one or several objects following one or several criterion, in a partial way or a complete way through an MMI (Man Machine Interface). A display and presentation module 10 yields a visualisation of researches over a map, enhancing geographic objects on the screen, and shows alphanumeric information relating to each geographic object resulting from the researches that have been carried out.

FIG. 2 shows a layered structure specific of a particular geomatic application.

This structure comprises a first layer 12 whose contents is the specification of the geomatic application, which, for example, could be the school premises management of a given town, a second layer 14 which defines the development language specific to the involved GIS, a third layer 16 which is the core of the involved GIS and a fourth layer 18 relateing to the operating system which manages the geomatic application. An example of GIS is MapInfo Professional® whose dedicated language is MapBasic. The geomatic application, for example, may be exploited under Windows 98/NT/XP.

Faced with the increasing number of application fields, whose main users are territorial authorities, the existing GIS are customised with difficulties as they are mainly “turnkey” proprietary tools. In case a user intends to develop an application starting from a given GIS, he has to develop specific programs to adapt his application to the given GIS. If the same user intends to develop a new application relying on the same GIS, he has to develop other programs for adapting the new application to the same GIS. The same way, if this user intends to exploit the same application with another GIS, he also has to develop specific programs to adapt the application to the new GIS.

Such adaptations usually require a specialist and induce extra costs which may be a burden for developing the project.

The purpose of the invention is to overcome the above mentioned inconveniences of prior art by means of a process which automatically generates customised and user-friendly geomatic applications, and makes the user able to exploit geographic as well as alphanumeric data in a transparent way.

### DESCRIPTION OF THE INVENTION

The invention then proposes a process for generating geomatic applications, comprising the steps of:

defining an application descriptive file formatted so as to be processed by a plurality of various Geographic Information Systems;

selecting a given Geographic Information Systems among the plurality of various Geographic Information Systems;

translating the formatted file into a language specific to the selected Geographic Information System.

The process according to the invention permits to automatically generate customised geomatic applications liable to be operated under various Geographic Information Systems such as, for example, MapInfo Professional® or a RunTime version of MapInfo Professional® as well as in an Intranet/Internet environment.

According to the invention, the translation step consists in linking the application describing file with at least one elementary software component selected from a memory which stores pre-defined elementary software components, according to parameters of the application descriptive file.

Following a preferred embodiment of the invention, the elementary software components storing memory comprises:

a software for assigning alphanumeric attributes to geographic objects.

a software for selecting an object in a cartographic map according to at least one criterion.

The process may be implemented over applications developed in an Intranet/Internet environment. In this case, the process according to the invention permits to create applications liable to deliver information in Java language.

In an Intranet context, the application descriptive file and the elementary software components are adapted to suit GIS professional users' needs.

It is the same in an Internet context. Moreover, the MMI interface is user-friendly for users who are not GIS specialists.

In all these applications, the elementary software components are instanciated, then linked together so as to make a new application during the translation step, before being automatically compiled during the executable version production step so that the user only runs, for example, the applets in HTML (Hyper Text Markup Language) pages.

Following another embodiment of the invention, the software elementary components memory besides includes a module intended for displaying the results of a research on a screen and a module for displaying at least one alphanumeric set of data relating to each geographic object resulting of said research.

Besides, the elementary software components memory preferentially includes:

one module for generating graphic tools for interactive selection of geographic objects;

one module for producing thematic analysis maps;

one module for interactive modification of parameters of said thematic analysis maps produced.

The invention also relates to a device for generating geomatic applications which implement the disclosed process.

This device is characterised in that it comprises an interface for defining a geomatic application descriptive file in a format which can be exploited by a plurality of various GIS, and a module for translating this descriptive file to match it to a given Geographic Information System selected among the plurality of various GIS.

Preferably, the device according to the invention comprises a memory which stores a plurality of elementary software components liable to be linked with the said descriptive file to automatically generate the specified geomatic application.

According to a preferred embodiment of the invention, the device comprises a Man Machine Interface including a first data acquisition module M1 for reading the descriptive file parameters, a second module M2 intended for delivering to the translation module the parameters which are specific of the geomatic application due to be generated and the elementary software components intended for adapting the said parameters to the selected GIS, and a module M3 which searches for the said elementary software components in the elementary software components memory.

Preferably, the elementary software components features:

one module for linking geographic objects with alphanumeric objects.

one module intended for searching an object in a cartographic map, following one criterion at least.

one module for displaying the research results on a screen.

This memory besides comprises a module at least displaying one alphanumeric information page linked to each geographic object, which lists the results from a research.

The process and the device according to the invention permit to obtain a transparent linkage between the alphanumeric data and the geographic data, without developing any program.

### BRIEF DESCRIPTION OF DRAWINGS

Other characteristics and advantages of the invention will be detailed in the following description, which discloses only an example of embodiment, in no way restrictive for the generality of the invention, accompanied by the annexed figures:

FIG. 1 shows the architecture of a Geographic Information System following the prior art,

FIG. 2 is a layered representation of a Geographic Information System following the prior art,

FIG. 3 shows a block-diagram of a device intended for implementing the process according to the invention.

FIG. 4 shows a preferred embodiment of the process implementation according to the invention.

### DETAILED DESCRIPTION OF PARTICULAR EMBODIMENTS

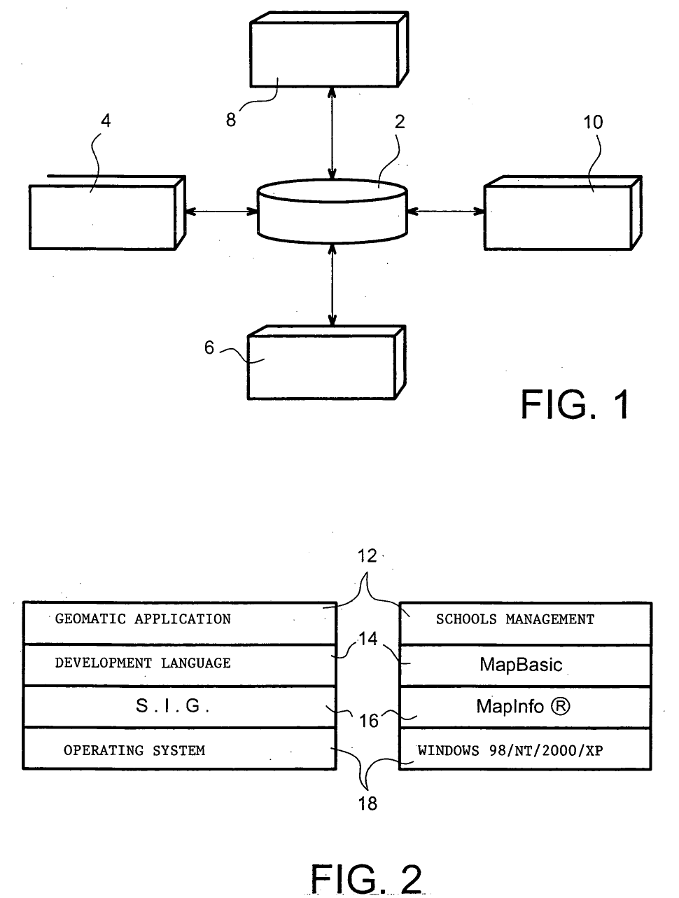

The above-mentioned FIGS. 1 and 2 describe the general architecture of a GIS and the structure of a software which implements a particular geomatic application in this GIS.

The disclosed invention consists in automatically generating customised, user-friendly, geomatic applications, allowing the user to transparently exploit geographic and alphanumeric data.

In the following, it will be called “primary user” any user liable to use the process according to the invention for generating geomatic applications and it will be called “end user” any person liable to exploit the information generated by the developed geomatic application.

To give an example, the primary user may be a local territorial authority wishing to exploit a graphic tool to manage street lighting, park areas or water supply. The territorial authority will develop its own application and will make it available to the public on an electronic display for example, or on an Internet portal.

The end user, in this case, is any person who needs screen-displayed information about street lighting, park areas or water supply conduits of his (her) district.

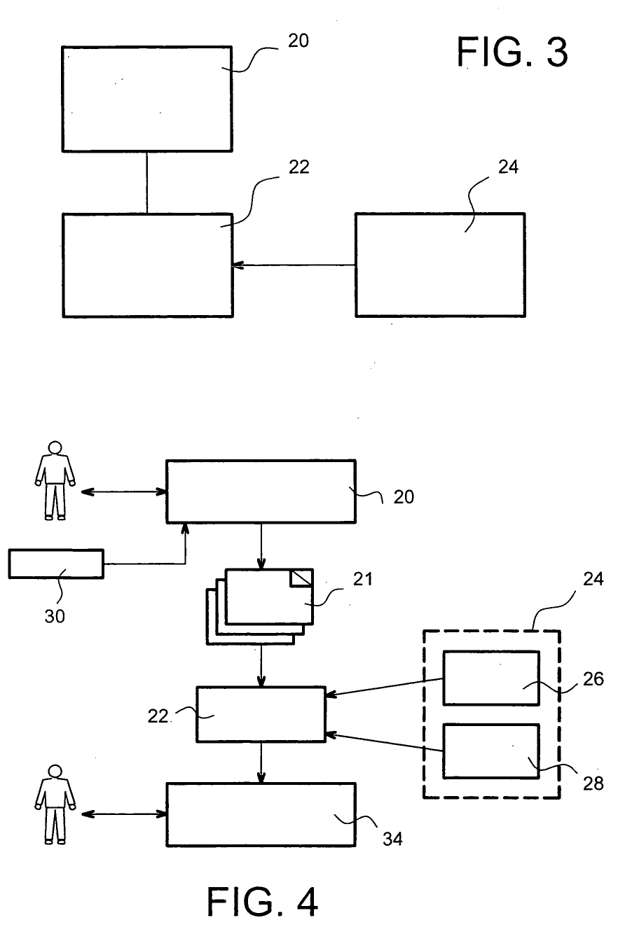

FIGS. 2 and 3 respectively show an automatic geomatic application generating device and the main generation steps thereof. This device includes one interface 20 to produce an application descriptive file 21 (see FIG. 4) for a particular geomatic application, one translation module 22 for translating the descriptive file 21 so as to adapt it to a particular Geographic Information System and one memory 24 storing a plurality of elementary software components intended for being linked to said descriptive file 21 to automatically generate the specified geomatic application.

Interface 20 includes a Man Machine Interface (MMI) which provides the primary user with graphic tools to define the features of the geomatic application.

Translation module 22 includes a software to link descriptive file 21 with one or several elementary software components whose number and respective functions depend on parameters stored in the descriptive file.

These elementary software components have been defined and stored beforehand in memory 24; their types may be split into two groups: a first group 26 of software which may be used as they are, with no modifications, and a second group 28 of software which may be instantiated via parameters which are delivered by the geomatic application descriptive file.

The elementary components of first group 26 may be used for any further geomatic application and are defined according to the involved GIS. The elementary components of second group 28 are modules which can be parameterised according to the considered application and to the involved GIS.

Referring to FIG. 4, first step 30 consists in elaborating a description of the intended geomatic application using interface 20 in the Man Machine Interface (MMI), which provides the primary user with graphic tools for defining the features of the geomatic application. To that end, the MMI comprises one first module M1 intended for delivering to interface 20 the descriptive file 21 parameters relating to the desired geomatic application, one second module M2 intended for delivering to translation module 22 the parameters which are relevant to the desired geomatic application and to the selected GIS. The information delivered by the second module M2 permits to determine the elementary software components required for generating the desired geomatic application. An M3 module is intended for selecting the said elementary software components from memory 24.

Interface 20 delivers the descriptive file 21 to translation module 22 in an intermediate format which is independent from the involved GIS language.

Translation module 22 uses the parameters delivered by module M2 to select the elementary software components from groups 26 and 28 of memory 24, which suit to the translation of descriptive file 21 into the language of the GIS used.

The elementary software components are then compiled by translation module 22 to yield the geomatic application described by file 21.

This newly generated application can be readily exploited by the user without any further development.

The process according to the invention also may be implemented in applications dedicated to interactive posts intended for non-specialist GIS users. In these types of applications, the MMI is configured for defining a presentation of information which responds to targeted general public requirements.

The process according to the invention may also be implemented in interactive applications liable to be recorded and executed on a CD-ROM type support.

1. A geomatic applications generating process, comprising the steps of:
defining a geomatic application descriptive file in a format suitable for a plurality of various Graphic Information Systems;
selecting a particular Geographic information system among the plurality of various Geographic Information Systems;
translating the file thus defined into a language specific to the selected Geographic Information System.

2. A process of claim 1, wherein the translation step consists in linking the descriptive file with at least one elementary software component, selected in a memory (24) of pre-defined elementary software components, according to parameters loaded in the descriptive file.

3. A process according to claim 2, wherein the elementary software components (24) includes:
one software for linking alphanumeric objects with geographic objects,
one software for searching for an object in a cartographic map according to one criterion at least.

4. A process according anyone of claim 1 to 3, wherein the memory (24) besides includes a module for visualising the results of a research on a screen.

5. A process according to claim 4, wherein the memory (24) besides includes a display module to display alphanumeric information data linked with each geographic object resulting from a research.

6. A process according to anyone of claims 1 to 5, wherein the elementary software components memory (24) besides includes:
one graphic tools generation module for interactive selection of graphic objects;
one module for producing thematic analysis maps;
one module intended for iterative modification of parameters of said thematic analysis maps.

7. A geomatic applications generation device, characterised in that it includes one interface (20) for defining a geomatic application descriptive file (21) of a geomatic application in a format which may be exploited by a plurality of various GIS and a module (2) for translating the said descriptive file (21) to adapt it to a particular Geographic Information System selected among the plurality of various GIS.

8. A device according to claim 7, wherein a memory (24) includes a plurality of elementary software components intended for linkage with said descriptive file (21) for automatically generating the specified application.

9. A device according to claim 8, wherein the elementary software components memory (24) is split into a first group (26) of predefined software and a second group (28) of software liable to be instantiated according to parameters stored in descriptive file (21).

10. A device according to anyone of claims 7 to 9, including a Man Machine Interface comprising a first module M1 intended for acquiring parameters from descriptive file (21), a second module M2 intended for delivering to translation module (22) parameters specific to the considered geomatic application which permits to determine the elementary software components required to generate this geomatic application in the selected GIS, and a module M3 intended for retrieving said elementary software components from memory (24).

11. A device according to claim 10, wherein memory (24) includes:
one module for linking alphanumeric objects with geographic objects,
one module for searching for an object in a cartographic map according to at least one criterion.
one module do display the research results on a screen.

12. A device according to claim 11, wherein memory (24) besides includes a module for displaying at least one data information page relating to each geographic object selected during a research.

13. Utilisation of the device according to anyone of claims 7 to 12, for generating a geomatic application to be run on an Internet Portal.

14. Utilisation of the device according to anyone of claims 7 to 12, for generating a geomatic application to be run on an interactive electronic post.

15. Utilisation of the device according to anyone of claims 7 to 12, for generating a geomatic application recorded on a recording support.

16. Recording support on which is recorded a geomatic application generated by means of the process according to anyone of claims 1 to 6.
